(19) United States
(12) Patent Application Publication
(10) Pub. No.: US 2025/0030176 A1
(43) Pub. Date: Jan. 23, 2025

(54) LOW-COST HIGH-GAIN DUAL POLARIZED BASE STATION AND USER EQUIPMENT ANTENNA ARRAY

(71) Applicant: Samsung Electronics Co., Ltd., Suwon-si (KR)

(72) Inventors: Jiantong Li, McKinney, TX (US); Aditya Dave, Plano, TX (US); Yong Su, Allen, TX (US); Xinguang Xu, Allen, TX (US); Won Suk Choi, McKinney, TX (US); Gang Xu, Allen, TX (US)

(21) Appl. No.: 18/777,234

(22) Filed: Jul. 18, 2024

Related U.S. Application Data
(60) Provisional application No. 63/528,163, filed on Jul. 21, 2023.

(51) Int. Cl. H01Q 21/24; H01Q 1/24; H01Q 21/06

(52) U.S. Cl. CPC H01Q 21/24; H01Q 1/246; H01Q 21/065

(57) ABSTRACT

An apparatus includes a via-fed dual-polarized patch, a first capacitive-fed dual-polarized patch, and a second capacitive-fed dual-polarized patch. The first capacitive-fed dual-polarized patch is capacitively coupled to the via-fed dual-polarized patch through an air gap. The second capacitive-fed dual-polarized patch is capacitively coupled to the first capacitive-fed dual-polarized patch through a dielectric layer.

### CROSS-REFERENCE TO RELATED APPLICATION AND PRIORITY CLAIM

This application claims priority under 35 U.S.C. § 119 (e) to U.S. Provisional Patent Application No. 63/528,163 filed on Jul. 21, 2023, which is hereby incorporated by reference in its entirety.

### TECHNICAL FIELD

This disclosure relates generally to multiple-input multiple-output (MIMO) antenna array devices and processes. More specifically, this disclosure relates to a low-cost high-gain polarized base station and user equipment (UE) antenna array.

### BACKGROUND

The growing demand for various wireless applications, such as wearables, virtual reality (VR), and automation, results in severe data traffic issues at commonly used bands, which necessitates the requirement of higher data rates. It is estimated that machines, especially high-resolution media and extended reality (XR), will be the dominant consumer type of future communication systems.

### SUMMARY

This disclosure provides a low-cost high-gain polarized base station and user equipment (UE) antenna array.

In a first embodiment, an apparatus includes a via-fed dual-polarized patch, a first capacitive-fed dual-polarized patch, and a second capacitive-fed dual-polarized patch. The first capacitive-fed dual-polarized patch is capacitively coupled to the via-fed dual-polarized patch through an air gap. The second capacitive-fed dual-polarized patch is capacitively coupled to the first capacitive-fed dual-polarized patch through a dielectric layer.

In a second embodiment, an electronic device includes an antenna array, transmit (TX) processing circuitry, and receive (RX) processing circuitry. The antenna array includes a via-fed dual-polarized patch, a first capacitive-fed dual-polarized patch, and a second capacitive-fed dual-polarized patch. The first capacitive-fed dual-polarized patch is capacitively coupled to the via-fed dual-polarized patch through an air gap. The second capacitive-fed dual-polarized patch is capacitively coupled to the first capacitive-fed dual-polarized patch through a dielectric layer. The TX processing circuitry is configured to provide signals to the antenna array. The RX processing circuitry is configured to receive signals from the antenna array.

In a third embodiment, a method includes capacitively coupling a first capacitive-fed dual-polarized patch to a via-fed dual-polarized patch through an air gap. The method also includes capacitively coupling a second capacitive-fed dual-polarized patch to the first capacitive-fed dual-polarized patch through a dielectric layer.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIGS. 2 and 3 illustrate example electronic devices in accordance with an embodiment of this disclosure;

FIGS. 4A and 4B illustrate an example mmW antenna array on an electronic device in accordance with this disclosure;

FIGS. 5A through 5C illustrate an example antenna array in accordance with this disclosure;

FIG. 6 illustrates an example flowchart of a design of the antenna array in accordance with this disclosure;

FIG. 7 illustrates an example antenna array in accordance with this disclosure;

FIG. 8 illustrates an example antenna array in accordance with this disclosure;

FIGS. 9A and 9B illustrate an example antenna array in accordance with this disclosure; and

FIG. 10 illustrates an example method for a low-cost high-gain polarized base station and user equipment (UE) antenna array according to this disclosure.

### DETAILED DESCRIPTION

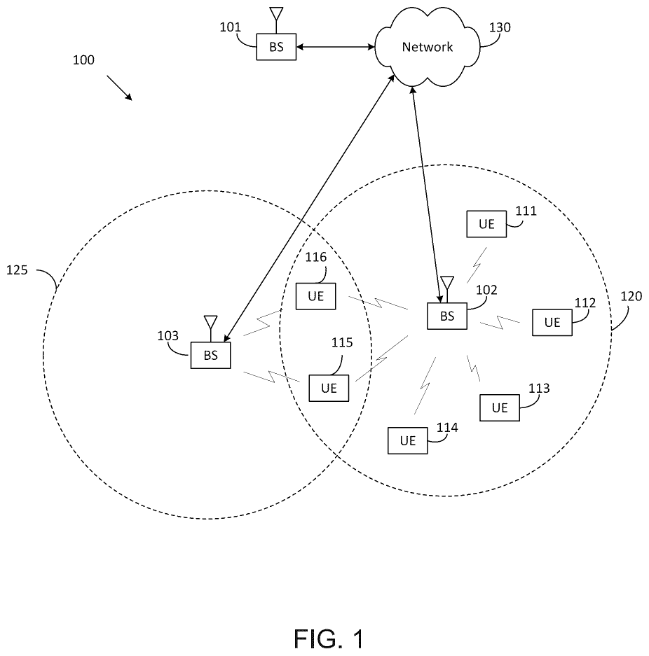

FIGS. 1 through 10, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As discussed above, wearables, virtual reality (VR), automation, and high-resolution media and extended reality (XR) machines may result in severe data traffic issues at commonly used bands, which necessitates the requirement of higher data rates. Multiple input, multiple output (MIMO) technology is one option to increase channel efficiency within the same spectrum. A massive MIMO configuration is utilized for 5G/6G base stations to improve the channel capacity by using a large number of antennas. With an antenna array of multiple elements, a narrower beam is formed, which can be spatial focused. Further, beamforming techniques are used to provide an interference-free and high-capacity link to each user, thus increasing the spatial resolution without increasing inter-cell complexity.

Compared with FR1 and FR2 bands, the FR3 band (7 GHz-24 GHz, also called upper middle band band) is capable of providing higher coverage and capacity for multiple users at the same time. Although FR3 band utilizes a lower frequency than 28 GHz of 5G band, it employs a larger antenna array with more than 1000 antenna elements, which targets at (1) high spectral efficiency, (2) extended coverage and (3) more layers of spatial multiplexing of both single-user MIMO (SU-MIMO) and multi-user MIMO (MU-MIMO).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

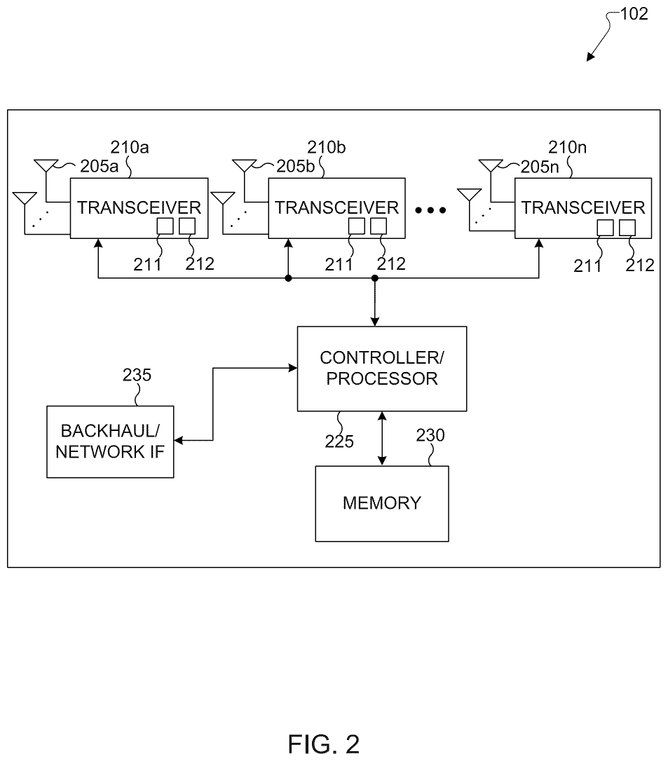

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry 211 in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry 212 in the transceivers 210a-210n and/or controller/processor 225 receives analog or digital data (such as voice data, web data, e-mail, or interactive video game data) from the controller/processor 225. The TX processing circuitry 212 encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

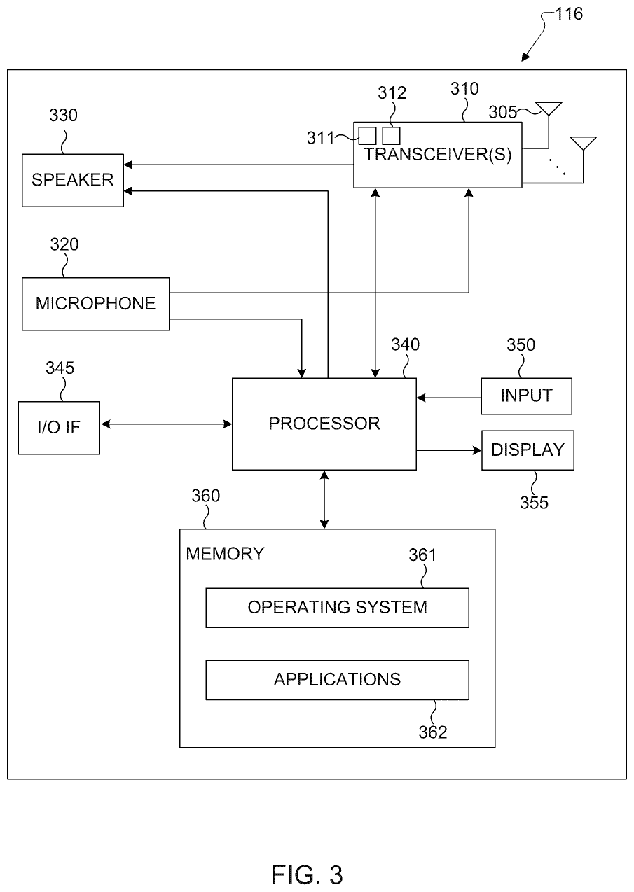

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry 311 in the transceiver(s) 310 and/or processor 340, which generates a processed baseband signal by filtering, decoding, and/or digitizing the baseband or IF signal. The RX processing circuitry 311 sends the processed baseband signal to the speaker 330 (such as for voice data) or is processed by the processor 340 (such as for web browsing data).

TX processing circuitry 312 in the transceiver(s) 310 and/or processor 340 receives analog or digital voice data from the microphone 320 or other outgoing baseband data (such as web data, e-mail, or interactive video game data) from the processor 340. The TX processing circuitry 312 encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

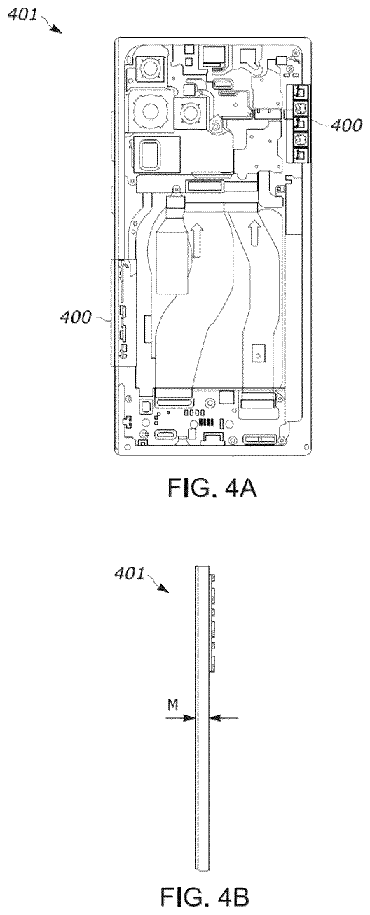

FIGS. 4A and 4B illustrate an example antenna array 400 on an electronic device 401 in accordance with this disclosure. The embodiments of the antenna array 400 illustrated in FIGS. 4A and 4B are for illustration only. FIGS. 4A and 4B do not limit the scope of this disclosure to any particular implementation of an electronic device.

As shown in FIGS. 4A and 4B, the electronic device 401 can include multiple antenna arrays 400. One antenna array 400 can face the side member, while another antenna array 400 can face the rear plate. As shown in Table 1, FR3 antenna arrays are supposed to maintain 1) multiple antennas facing two directions; 2) beamforming and spatial multiplexing; 3) dual polarization; 4) high boresight gain; and 5) low cost and easy fabrication.

TABLE 1

| Antennas | FR1 (3.5 GHz) | FR2 (28 GHz) | FR3 (13 GHz) |
|---|---|---|---|
| Wavelength | 85.7 mm | 10.71 mm | 23.07 mm |
| Operation | No beamforming | Beamforming | Beamforming + |
| | Spatial | Module | Spatial |
| | multiplexing | switching | multiplexing |
| Number of data | At most 4 layers | 2 layers | At most 8 layers |
| layers | | | |
| UE Configuration | 1 or 2 PIFA ants | 2 patch arrays | 2 patch arrays |
| (phone) | | | |
| UE location | Back | Back, Edge | Back, Edge |
| (phone) | | | |

Because the frequency is low for an FR1 antenna, that means the wavelength is large. A planar inverted-F antenna (PIFA) can be selected as a simple FR1 antenna and can be used on the back or edges of a cell phone due to the length and frequency of the PIFA. The sizes of the antennas increase for the FR2 band and usually require working as an array. For example, a 1×5 antenna array can be used for the FR2 band. This allows for a smaller size of each antenna in the array and can be placed along with the antenna operating in the FR1 band.

Antenna arrays can also be used because post-5G or potential 6G can perform beam forming and other advanced functionalities. The antenna arrays can be used as a group of antenna elements to support the advanced communication requirements from 5G or 6G.

As mentioned before, the antenna must fit in a phone with the size requirements for the thickness of the phone, such as 7.6 mm. However, the phone may have a case or have some plastic material to separate components from metal and space for other components, which reduces the available thickness further. For example, when the total thickness is 7.6 mm, the available phone thickness for the antenna may be 5.5 mm or less. For a thickness of 5.5 mm, the fixed height of the wavelengths may be approximately 0.5 wavelengths, which is almost a wavelength of 0.5 wavelengths or half wavelengths. But this height for a different frequency for the FR3 band would only be 0.24 wavelengths, which is half because the frequency is almost half of the FR2 band. The wavelength is suitable for FR2, but the FR3 band will have a very small area, which can influence the overall performance.

Although FIGS. 4A and 4B illustrate an example antenna array 400 on an electronic device 401, various changes may be made to FIGS. 4A and 4B. For example, the number and placement of various components of the antenna array 400 can vary as needed or desired. In addition, the antenna array 400 may be used in any other suitable telecommunications process and is not limited to the specific processes described above.

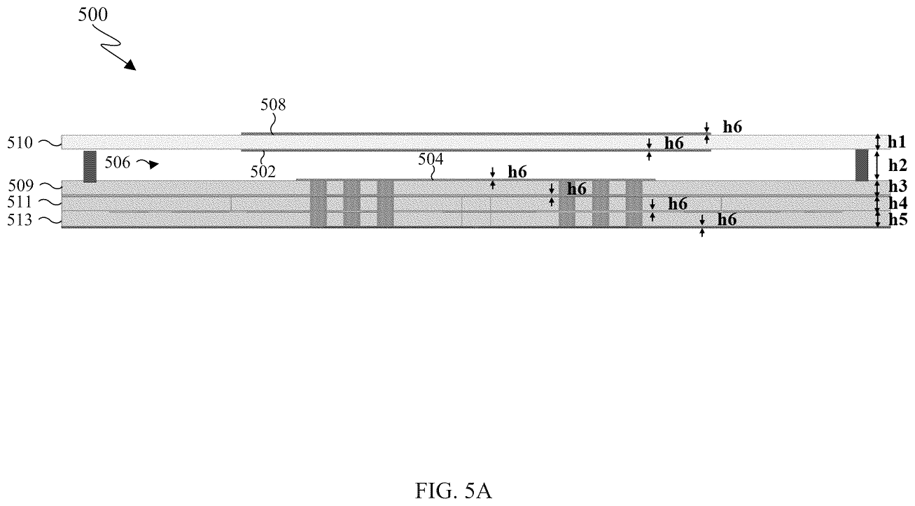

FIGS. 5A through 5C illustrate an example antenna array 500 in accordance with this disclosure. The embodiments of the antenna array 500 illustrated in FIGS. 5A through 5C are for illustration only. FIGS. 5A through 5C do not limit the scope of this disclosure to any particular implementation of an electronic device. While the following illustrates a design of an antenna array 500 with four antenna elements, the design can be extended to other antenna element sizes, e.g., a three antenna element array, a six antenna element array, a seven antenna element array, etc.

As shown in FIGS. 5A through 5C, the antenna array 500 can include five metal layers and four dielectric layers. One of the metal layers can include a via-fed dual-polarized patch 502. The via-fed dual-polarized patch 502 can be capacitively coupled to a first capacitive-fed dual polarized patch 504 through an air gap 506. The via-fed dual-polarized patch 502 can be capacitively coupled to a second capacitive-fed dual polarized patch 508 through a dielectric layer 510. The first capacitive-fed dual polarized patch 504 can be positioned on an opposite side of the via-fed dual-polarized patch 502 from the second capacitive-fed dual polarized patch 508. The via-fed-polarized patch can have a length or width in an inclusive range of 0.3-0.35λ₀. The first and second capacitive-fed dual-polarized patches 504 and 508 can have a length or width in an inclusive range of 0.35-0.4λ₀. The air gap can have a thickness of 0.015-0.025λ₀. The dielectric layer 510 can have a thickness in an inclusive range of 0.01-0.015λ0.

In certain embodiments, the antenna array 500 can include six metal layers and four dielectric layers separating the metal layers. Each of the metal layers can have a thickness of approximately 1.4 mil and be made of 1 oz of copper. A first metal layer 512 can function as an antenna layer and include a plurality of the first capacitive-fed dual polarized patches 504. A first dielectric layer, such as dielectric layer 510, can separate the first metal layer 512 from a second metal layer 514. The first dielectric layer 510 can have a thickness of approximately 10 mil, a relative permittivity of approximately 3.1, and a dissipation factor of approximately 0.0018.

The second metal layer 514 can function as a frame and includes a plurality of via-fed dual-polarized patches 502. The air gap 506 can separate the second metal layer 514 from a third metal layer 516. The second dielectric layer 805 can have a thickness of approximately 18.1 mil, a relative permittivity of approximately 3.1, and a dissipation factor of approximately 0.0018.

The third metal layer 516 can include a plurality of second capacitive-fed dual polarized patches 508. A second dielectric layer 509 can separate the third metal layer 516 from a fourth metal layer 518. The second dielectric layer 509 can have a thickness of approximately 8 mil, a relative permittivity of approximately 3.24, and a dissipation factor of approximately 0.0022.

The fourth metal layer 518 can function as a ground. A third dielectric layer 511 can separate the fourth metal layer 810 from a fifth metal layer 520. The third dielectric layer 511 can have a thickness of approximately 8 mil, a relative permittivity of approximately 3.24, and a dissipation factor of approximately 0.0022.

The fifth metal layer 520 can function as a 45° and 135° polarization power divider. A fourth dielectric layer 513 can separate the fifth metal layer 520 from a sixth metal layer 522. The fourth dielectric layer 513 can have a thickness of approximately 8 mil, a relative permittivity of approximately 3.24, and a dissipation factor of approximately 0.0022. The sixth metal layer 522 can function as a ground.

As shown in FIG. 5C, the second capacitive-fed dual-polarized patches 508 can be structure as an x-shaped dual polarized antenna unit-cell. The straight feeding line 530 supports the 45-deg polarization and the curved feeding line 532 supports the 135-deg polarization, which can differentially feed two ports along one polarization. The etched x-shape configuration is utilized to reduce the mutual coupling. Several ground vias are located near the feeding vias for the sake of impedance matching. Instead of integrating the antenna panel with the main board, antenna array 500 utilizes three layers of main board to fabricate ground, power divider, and capacitive patch layers. As the antenna module can share the space of the main board, the fabrication cost reduces to 20-30%. Another single-layer board can be used for receiving the power from the capacitive patch, which fabricate metal-dielectric-metal configuration without using any complex vias, slots and pads. Table 2 presents the summary of key parameters with the ratio of free-space wavelength.

TABLE 2

| Parameters | h1 | h2 | h3 | h4 | h5 | h6 | s1 | s2 | d1 |
|---|---|---|---|---|---|---|---|---|---|
| Value | 0.011 | 0.022 | 0.011 | 0.011 | 0.011 | 0.001 | 0.65 | 0.195 | 0.013 |
| Parameters | d2 | d3 | d4 | w1 | w2 | w3 | l1 | l2 | l3 |
| Value | 0.011 | 0.02 | 0.022 | 0.37 | 0.37 | 0.28 | 0.136 | 0.515 | 0.086 |
| Parameters | l4 | l5 | l6 | l7 | l8 | l9 | l10 | l11 | l12 |
| Value | 0.043 | 0.277 | 0.043 | 0.072 | 0.043 | 0.043 | 0.275 | 0.04 | 0.06 |

| Parameters | l13 | l14 | l15 |
|---|---|---|---|
| Value | 0.06 | 0.08 | 0.08 |

Although FIGS. 5A through 5C illustrate an example antenna array 500, various changes may be made to FIGS. 5A through 5C. For example, the number and placement of various components of the antenna array 500 can vary as needed or desired. In addition, the antenna array 500 may be used in any other suitable telecommunications process and is not limited to the specific processes described above.

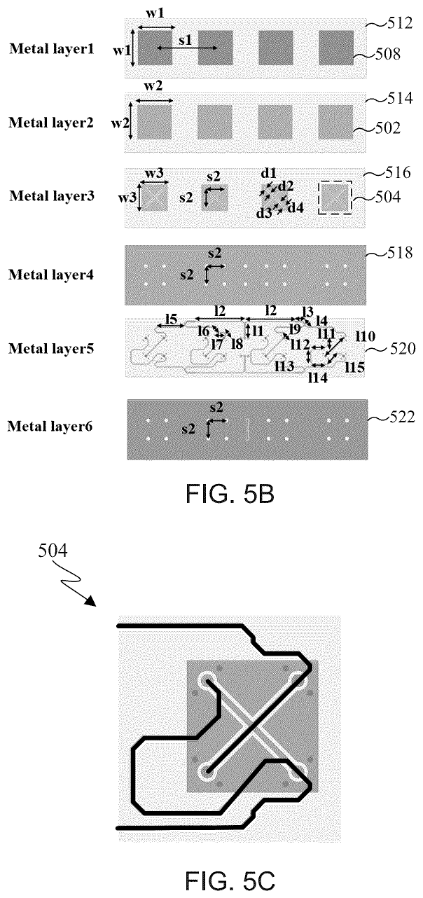

FIG. 6 illustrates an example flowchart 600 of a design of the antenna array in accordance with this disclosure. For ease of explanation, the flowchart 600 of FIG. 6 is described as being performed using the electronic device 401 of FIG. 4. However, the flowchart 600 may be used with any other suitable system and any other suitable electronic device.

As shown in FIG. 6, a massive MIMO system can be designed in step 602. The massive MIMO can include the antenna array 500.

A theoretical analysis of unit-cells can be performed for the antenna array at step 604. The theoretical analysis of a unit-cell can be performed to determine different measurements of unit-cells to perform communication in antenna array 500. Different measurements can be analyzed for determining optimal dimensions.

A circuit analysis of unit-cells can be performed for the antenna array 500 at step 606. A representative circuit can be provided for the unit-cell based on the dimensions determined in the theoretical analysis. The circuit analysis can provide experimental results to confirm the results of the theoretical analysis.

A numerical model of a unit-cell of the antenna array 500 can be performed at step 608. Based on assumptions of ideal environment without considerations of specific array configurations, numerical methods can be used to analyze electromagnetic fields of each port-to-port coupling.

Single element parameters can be optimized for the antenna array 500 in step 610. The results of the different analysis can be used to determine optimal dimensions for each of the antenna elements in the antenna array. The optimal dimensions can be determined based on specified frequency band and spacing dimensions.

The dual-polarization parameters can be optimized for the antenna array 500 in step 612. The results of the different analysis can be used to determine optimal dimensions for each of the antenna elements in the antenna array for dual band functionality.

The power divider parameters can be optimized for the antenna array 500 in step 614. The results of the different analysis can be used to determine optimal dimensions for each of the antenna elements in the antenna array for power divider functionality.

The four-element array parameters can be optimized for the antenna array 500 in step 616. The results of the different analysis can be used to determine optimal dimensions for each pair of antenna elements in the antenna array.

The 1×4 array parameters can be optimized for the antenna array in step 618. The results of the different analysis can be used to determine optimal dimensions for the antenna elements in the antenna array for operating at the 1×4 array.

The large array parameters can be optimized for the antenna array in step 620. The results of the different analysis can be used to determine optimal dimensions for the antenna elements in the antenna array for beamforming.

The antenna design process can be repeated for different embodiments at step 622. The different embodiments can be used in steps 602-620. The results of the different embodiments can also be compared to determine an optimal antenna design.

Although FIG. 6 illustrates one example of a flowchart 600 of a design of the antenna array, various changes may be made to FIG. 6. For example, while shown as a series of steps, various steps in FIG. 6 may overlap, occur in parallel, or occur any number of times.

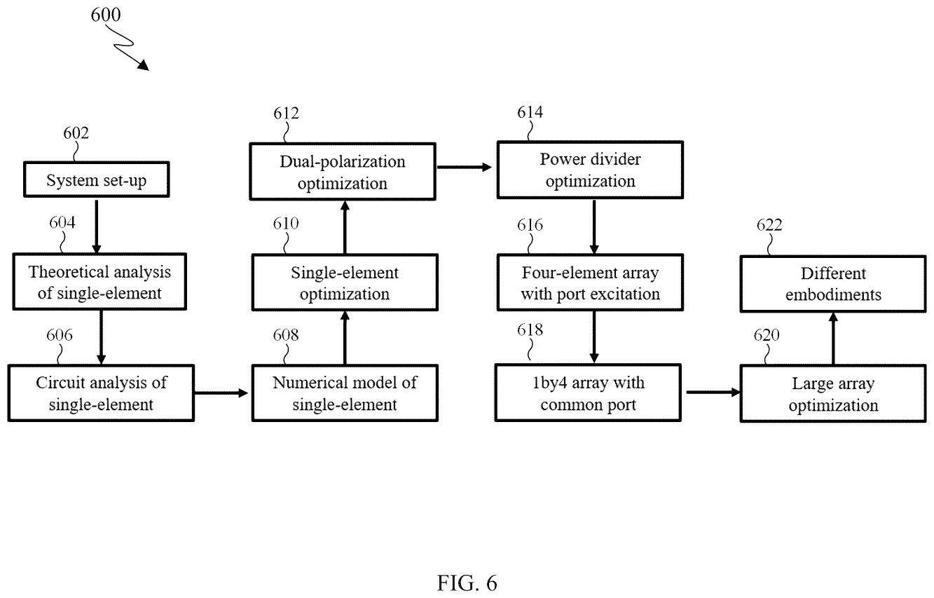

FIG. 7 illustrates an example antenna array 700 in accordance with this disclosure. The embodiment of the antenna array 700 illustrated in FIG. 7 is for illustration only. FIG. 7 does not limit the scope of this disclosure to any particular implementation of an electronic device.

As shown in FIG. 7, antenna array 700 has the same layers for the metal layers 512-522, the air gap 506, and dielectric layers 509-513. For a radiating antenna layer, antenna array 700 uses a plastic layer with metal elements, integrated with plastic posts 704, which further reduce the cost via a conformal approach. Rather than standard PCB material, the low-loss material can be used to support the radiating antennas.

Although FIG. 7 illustrates an example antenna array 700, various changes may be made to FIG. 7. For example, the number and placement of various components of the antenna array 700 can vary as needed or desired. In addition, the antenna array 700 may be used in any other suitable telecommunications process and is not limited to the specific processes described above.

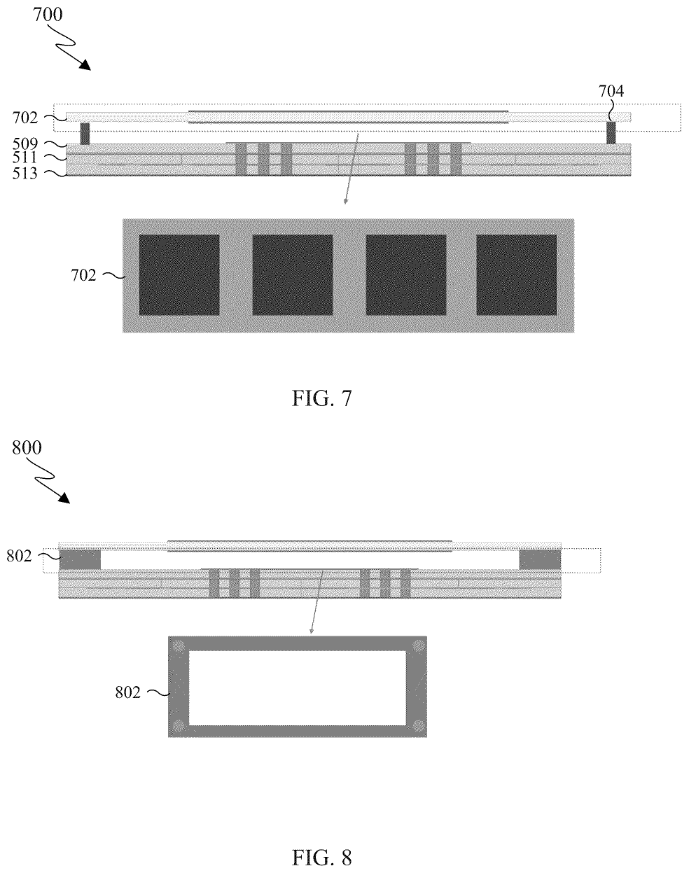

FIG. 8 illustrates an example antenna array 800 in accordance with this disclosure. The embodiment of the antenna array 800 illustrated in FIG. 8 is for illustration only. FIG. 8 does not limit the scope of this disclosure to any particular implementation of an electronic device.

As shown in FIG. 8, example antenna array 800 incorporates a dielectric planar structure 802 for use with the FR3 antennas. In an air-suspended configuration, the supporting posts maintain mechanical stability without interfering with the radiation fields. Compared with cylindrical posts, the planar structure 802 can be another candidate to elevate the radiating antenna layer with the thickness of plastic boards. For example, polyurethanes are used with the dielectric of 1.04 and loss tangent of 0.002, which is similar to air property. Table 3 shows dielectric constants and loss tangents at different frequencies for each sample.

TABLE 3

| | DIELECTRIC CONSTANT AT | | | LOSS TANGENT, (TAN, DELTA) | | |
|---|---|---|---|---|---|---|
| | THE FREQUENCY, GHZ, OF | | | AT THE FREQUENCY, GHZ, OF | | |
| SAMPLE | 1.00 | 5.00 | 10.00 | 1.00 | 5.00 | 10.00 |
| FR-3703 | 1.08 | 1.05 | 1.04 | 0.00164 | 0.00172 | 0.000170 |
| FR-3710 | 1.16 | 1.08 | 1.07 | 0.00177 | 0.00183 | 0.00184 |
| FR-3718 | 1.21 | 1.13 | 1.11 | 0.00218 | 0.00229 | 0.00233 |
| FR-7106 | 1.09 | 1.05 | 1.03 | 0.00171 | 0.00180 | 0.00186 |
| FR-7108 | 1.13 | 1.11 | 1.10 | 0.00174 | 0.00183 | 0.00185 |
| FR-7115 | 1.18 | 1.10 | 1.08 | 0.00206 | 0.00219 | 0.00222 |
| R-9807 | 1.10 | 1.05 | 1.05 | 0.00176 | 0.00187 | 0.00191 |

Although FIG. 8 illustrates an example antenna array 800, various changes may be made to FIG. 8. For example, the number and placement of various components of the antenna array 800 can vary as needed or desired. In addition, the antenna array 800 may be used in any other suitable telecommunications process and is not limited to the specific processes described above.

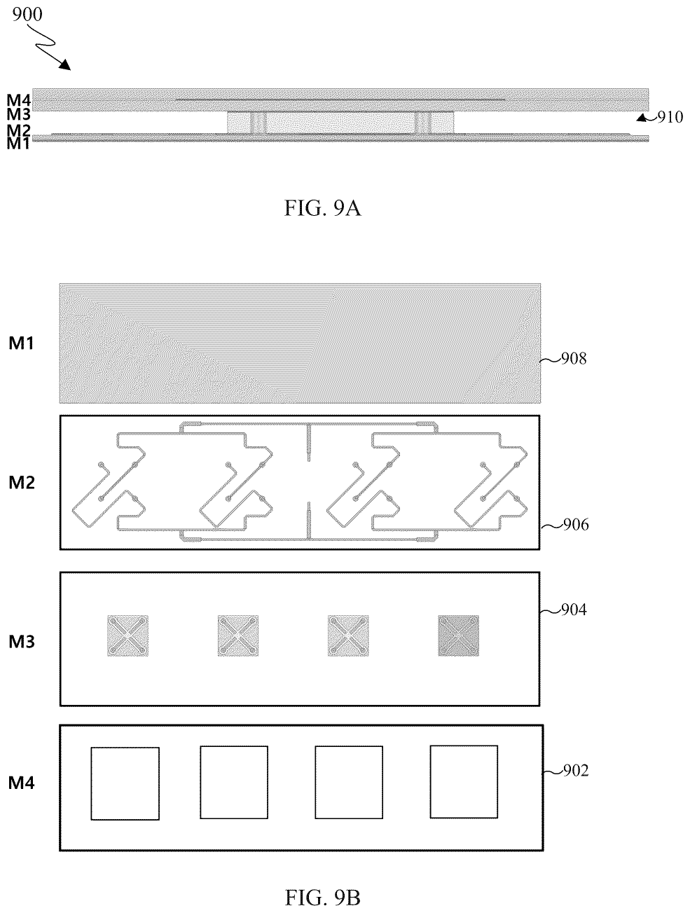

FIGS. 9A and 9B illustrate an example antenna array 900 in accordance with this disclosure. The embodiments of the antenna array 900 illustrated in FIGS. 9A and 9B are for illustration only. FIGS. 9A and 9B do not limit the scope of this disclosure to any particular implementation of an electronic device.

As shown in FIGS. 9A and 9B, antenna array 900 has four metal layers 902-908. An air gap 910 is incorporated between the second and third metal layers 904 and 906. Each of the metal layers 902-908 can have a thickness of approximately 1.4 mil and be made of 1 oz of copper. A first metal layer 902 can function as an antenna layer. A first dielectric layer 912 can separate the first metal layer 902 from the second metal layer 904. The first dielectric layer 912 can have a thickness of approximately 10 mil, a relative permittivity of approximately 3.1, and a dissipation factor of approximately 0.0018.

The second metal layer 514 can include a plurality of via-fed dual-polarized patches 502. The air gap 910 can separate the second metal layer 904 from a third metal layer 906. The third metal layer 906 can function as a 45° and 135° polarization power divider. A third dielectric layer 914 can separate the third metal layer 906 from a fourth metal layer 908. The third dielectric layer 914 can have a thickness of approximately 8 mil, a relative permittivity of approximately 3.24, and a dissipation factor of approximately 0.0022. The fourth metal layer 908 can function as a ground.

Although FIGS. 9A and 9B illustrate an example antenna array 700, various changes may be made to FIGS. 9A and 9B. For example, the number and placement of various components of the antenna array 700 can vary as needed or desired. In addition, the antenna array 700 may be used in any other suitable telecommunications process and is not limited to the specific processes described above.

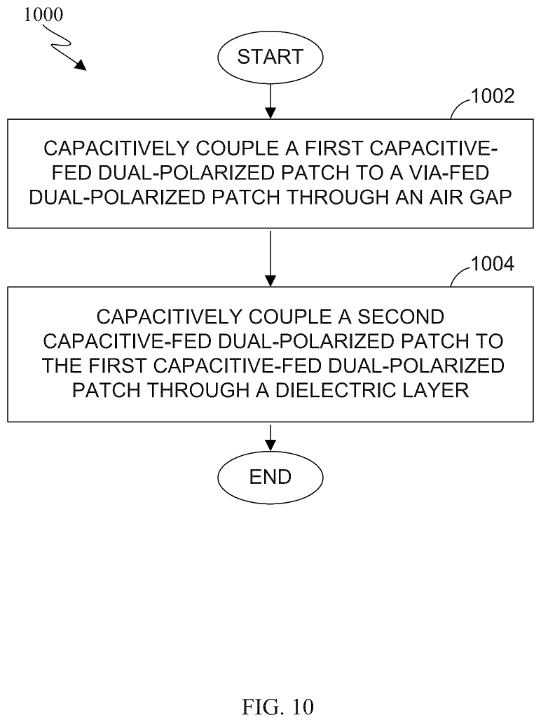

FIG. 10 illustrates an example method 1000 for a low-cost high-gain polarized base station and user equipment (UE) antenna array according to this disclosure. For ease of explanation, the method 1000 of FIG. 10 is described as being performed using the antenna array 500 of FIGS. 5A through 5C. However, the method 1000 may be used with any other suitable system and any other suitable electronic device.

As shown in FIG. 10, a first capacitive-fed dual-polarized patch can be capacitively coupled to a via-fed dual-polarized patch through an air gap at step 1002. The via-fed dual-polarized patch can have a width or a length in an inclusive range of 0.3-0.35λ₀. The first capacitive-fed dual-polarized patch can have a width or a length in an inclusive range of 0.3-0.35λ₀. The air gap can have a distance in an inclusive range of 0.015-0.025λ₀.

The antenna array 500 includes a second capacitive-fed dual-polarized patch can be capacitively coupled to the via-fed dual-polarized patch through a dielectric layer at step 1004. the second capacitive-fed dual-polarized patch has a width or a length in an inclusive range of 0.35-0.4λ₀. The dielectric layer can have a thickness in an inclusive range of 0.01-0.015λ₀. The second capacitive-fed dual-polarized patch can include one or more antenna elements having an X-shaped dual-polarized configuration. The one or more antenna elements can have a length in an inclusive range of 0.25-0.3λ₀ and a width in an inclusive range of 0.008-0.015λ₀. The one or more antenna elements can be configured with a given wavelength. The one or more antenna elements can be applicable in different frequency bands.

Although FIG. 10 illustrates one example of a method 1000 for a low-cost high-gain polarized base station and user equipment (UE) antenna array, various changes may be made to FIG. 10. For example, while shown as a series of steps, various steps in FIG. 10 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a via-fed dual-polarized patch;
a first capacitive-fed dual-polarized patch capacitively coupled to the via-fed dual-polarized patch through an air gap; and
a second capacitive-fed dual-polarized patch capacitively coupled to the first capacitive-fed dual-polarized patch through a dielectric layer.

2. The apparatus of claim 1, wherein the second capacitive-fed dual-polarized patch includes one or more antenna elements having an X-shaped dual-polarized configuration.

3. The apparatus of claim 2, wherein the one or more antenna elements have a length in an inclusive range of 0.25-0.3λ₀ and a width in an inclusive range of 0.008-0.015λ₀.

4. The apparatus of claim 2, wherein:
the one or more antenna elements are configured with a given wavelength, and
the one or more antenna elements are applicable in different frequency bands.

5. The apparatus of claim 3, wherein:
the via-fed dual-polarized patch has a width or a length in an inclusive range of 0.3-0.35λ₀,
the first capacitive-fed dual-polarized patch has a width or a length in an inclusive range of 0.3-0.35λ₀, and
the second capacitive-fed dual-polarized patch has a width or a length in an inclusive range of 0.35-0.4λ₀.

6. The apparatus of claim 1, wherein the air gap has a distance in an inclusive range of 0.015-0.025λ₀.

7. The apparatus of claim 1, wherein the dielectric layer has a thickness in an inclusive range of 0.01-0.015λ₀.

8. An electronic device comprising:
an antenna array including:
a via-fed dual-polarized patch;
a first capacitive-fed dual-polarized patch capacitively coupled to the via-fed dual-polarized patch through an air gap; and
a second capacitive-fed dual-polarized patch capacitively coupled to the first capacitive-fed dual-polarized patch through a dielectric layer,
transit (TX) processing circuitry configured to provide signals to the antenna array, and
receive (RX) processing circuitry configured to receive signals from the antenna array.

9. The electronic device of claim 8, wherein the second capacitive-fed dual-polarized patch includes one or more antenna elements having an X-shaped dual-polarized configuration.

10. The electronic device of claim 9, wherein the one or more antenna elements have a length in an inclusive range of 0.25-0.3λ₀ and a width in an inclusive range of 0.008-0.015λ₀.

11. The electronic device of claim 9, wherein;
the one or more antenna elements are configured with a given wavelength, and
the one or more antenna elements are applicable in different frequency bands.

12. The electronic device of claim 11, wherein:
the via-fed dual-polarized patch has a width or a length in an inclusive range of 0.3-0.35λ₀,
the first capacitive-fed dual-polarized patch has a width or a length in an inclusive range of 0.3-0.35λ₀, and
the second capacitive-fed dual-polarized patch has a width or a length in an inclusive range of 0.35-0.4λ₀.

13. The electronic device of claim 8, wherein the air gap has a distance in an inclusive range of 0.015-0.025λ₀.

14. The electronic device of claim 8, wherein the dielectric layer has a thickness in an inclusive range of 0.01-0.015λ₀.

15. A method of using an antenna comprising:
capacitively coupling a first capacitive-fed dual-polarized patch to a via-fed dual-polarized patch through an air gap; and
capacitively coupling a second capacitive-fed dual-polarized patch to the first capacitive-fed dual-polarized patch through a dielectric layer.

16. The method of claim 15, wherein the second capacitive-fed dual-polarized patch includes one or more antenna elements having an X-shaped dual-polarized configuration.

17. The method of claim 16, wherein the one or more antenna elements have a length in an inclusive range of 0.25-0.3λ₀ and a width in an inclusive range of 0.008-0.015λ₀.

18. The method of claim 16, wherein:
the one or more antenna elements are configured with a given wavelength, and
the one or more antenna elements are applicable in different frequency bands.

19. The method of claim 18, wherein:
the via-fed dual-polarized patch has a width or a length in an inclusive range of 0.3-0.35λ₀,
the first capacitive-fed dual-polarized patch has a width or a length in an inclusive range of 0.3-0.35λ₀, and
the second capacitive-fed dual-polarized patch has a width or a length in an inclusive range of 0.35-0.4λ₀.

20. The method of claim 15, wherein:
the air gap has a distance in an inclusive range of 0.015-0.025λ₀, and
the dielectric layer has a thickness in an inclusive range of 0.01-0.015λ₀.
